(19) United States
(12) Patent Application Publication
(10) Pub. No.: US 2023/0326629 A1
(43) Pub. Date: Oct. 12, 2023

(54) TRANSMISSION LINE WITH SMALLER END AREA

(71) Applicant: EDOM Technology Co., Ltd., Taipei City (TW)

(72) Inventor: HSIANG-JEN WANG, Taipei City (TW)

(21) Appl. No.: 17/958,607

(22) Filed: Oct. 3, 2022

Related U.S. Application Data
(60) Provisional application No. 63/329,548, filed on Apr. 11, 2022.

(51) Int. Cl. H01B 11/18

(52) U.S. Cl. CPC H01B 11/1869; H01B 11/1813; H01B 11/1808; H01B 11/1895; H01B 11/1891

(57) ABSTRACT

This disclosure is a transmission line, which comprises an inner conducting core, an insulation layer, a conductive layer and an outer sheath. The insulation layer covers the inner conducting core, the conductive layer covers the insulation layer, and the outer sheath covers the conductive layer. The outer sheath at one end or both ends of the transmission line includes a thinned part, wherein the cross-sectional area of the thinned part is smaller than that of the outer sheath. The conductive layer is folded to the thinned part of the outer sheath, and forms a folded part on the thinned part to reduce the cross-sectional area of one end or both ends of the transmission line. A connector is connected to the transmission line without reducing the wire diameter of the inner conducting core, so as to increase the signal transmission distance of the transmission line.

### REFERENCE TO RELATED APPLICATIONS

This non-provisional application claims priority under 35 U.S.C. § 119(a) on U.S. Provisional Application No. 63329548 filed Apr. 11, 2022, the entire contents of which are incorporated herein by reference.

### BACKGROUND

### Technical Field

This disclosure relates to a transmission line, which is beneficial to reduce the cross-sectional area of the end of the transmission line.

### Related Art

Transmission lines can be used to transmit high-frequency signals. During the transmission process of high-frequency signals, the transmission line radiates an electromagnetic field, resulting in energy loss of high-frequency signals. Therefore, the transmission line is usually provided with a shielding layer to prevent the energy loss of high-frequency signals and the interference of any existing electromagnetic field around it.

Coaxial cable is a kind of transmission line, which is widely used in communication, computer, local area network, automobile, medical equipment and other fields. Coaxial cables are usually four-layer construction. The innermost layer is a copper core which is covered by an inner dielectric insulator. A woven copper shield is arranged outside the inner dielectric insulator to reduce to prevent the energy loss and the interference of electromagnetic field around the coaxial cable. An outer plastic sheath is arranged outside the woven copper shield.

According to the size of the coaxial cable, there are various standard specifications. For example, the wide diameter of the cable is about 0.24 mm to 2.5 mm. The signal transmission distance of the coaxial cable is related to the wire diameter. When the wire diameter of the coaxial cable is larger, the signal can be transmitted to a longer distance.

### SUMMARY

This disclosure provides a transmission line, which includes at least one inner conducting core, an insulation layer, a conductive layer and an outer sheath. The insulation layer covers the inner conducting core, the conductive layer is arranged outside the insulation layer, and the outer sheath covers the conductive layer.

A thinned part is provided on the outer sheath at one or both ends of the transmission line, wherein the cross-sectional area of the thinned part is smaller than that of the outer sheath. The conductive layer is folded to the thinned part to form a folded part at one or both ends of the transmission line. When the transmission line is connected to connectors of the same specification, the wire diameter of the transmission line of this disclosure will be larger than that of the general transmission line to increase the signal transmission distance of the transmission line.

To achieve the object, this disclosure provides a transmission line, which comprises: an inner conducting core; an insulation layer covering an outer peripheral surface of the inner conducting core; a conductive layer covering an outer peripheral surface of the insulation layer; an outer sheath covering an outer peripheral surface of the conductive layer, wherein the outer sheath at one or both ends of the transmission line includes a thinned part, and part of the conductive layer is located on the thinned part; a metal shell covering the conductive layer on the thinned part; and an insulation shell deposed on part of the metal shell and part of the outer sheath.

This disclosure further provides a transmission line, which comprising: a plurality of conducting wires, including: an inner conducting core; an insulation layer covering an outer peripheral surface of the inner conductor core wire; a conductive layer covering the plurality of conducting wires; an outer sheath covering an outer peripheral surface of the conductive layer, wherein the outer sheath at one or both ends of the transmission line includes a thinned part, and part of the conductive layer is located on the thinned part; a metal shell covering the conductive layer on the thinned part; and an insulation shell covers part of the metal shell and part of the outer sheath.

### BRIEF DESCRIPTION OF THE DRAWINGS

This disclosure will become more fully understood from the detailed description given herein below for illustration only, and thus not limitative of this disclosure, wherein:

FIG. 1 is a schematic three-dimensional of a transmission line according to an embodiment of this disclosure.

FIG. 2 is a cross view of the transmission lien according to an embodiment of this disclosure.

FIG. 3 is a schematic three-dimensional of a thinned part of the transmission line according to an embodiment of this disclosure.

FIG. 4 is a schematic three-dimensional of a thinned part of the transmission line according to another embodiment of this disclosure.

FIG. 5 is a schematic three-dimensional of a thinned part of the transmission line according to another embodiment of this disclosure.

FIG. 6 is a schematic three-dimensional of a thinned part of the transmission line according to another embodiment of this disclosure.

FIG. 7 is a schematic three-dimensional of the transmission line according to another embodiment of this disclosure.

FIG. 8 is a cross view of the transmission line according to another embodiment of this disclosure.

FIG. 9 is a schematic three-dimensional of the transmission line according to another embodiment of this disclosure.

FIG. 10 is a cross view of the transmission line according to another embodiment of this disclosure.

FIG. 11 is a schematic three-dimensional of the transmission line according to another embodiment of this disclosure.

FIG. 12 is a cross view of the transmission line according to another embodiment of this disclosure.

FIG. 13 is a cross view of the transmission line according to another embodiment of this disclosure.

FIG. 14 is a cross view of the transmission line according to another embodiment of this disclosure.

FIG. 15 is a schematic three-dimensional of the transmission line according to another embodiment of this disclosure.

FIG. 16 is an axial cross view of the transmission lien according to another embodiment of this disclosure.

FIG. 17 is a schematic three-dimensional of the transmission line according to another embodiment of this disclosure.

FIG. 18 is an axial cross view of the transmission lien according to another embodiment of this disclosure.

FIG. 19 is a radial cross view of the transmission lien according to another embodiment of this disclosure.

FIG. 20 is a radial cross view of the transmission lien according to another embodiment of this disclosure.

FIG. 21 is a radial cross view of the transmission lien according to another embodiment of this disclosure.

### DETAILED DESCRIPTION

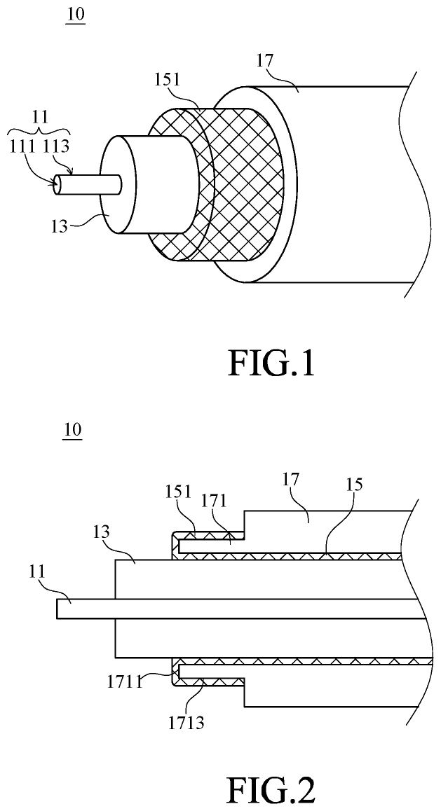

FIG. 1 is a schematic three-dimensional of a transmission line according to an embodiment of this disclosure. FIG. 2 is a cross view of the transmission lien according to an embodiment of this disclosure. The transmission line 10 includes an inner conducting core 11, an insulation layer 13, a conductive layer 15 and an outer sheath 17, wherein the insulation layer 13 is configured to cover an outer peripheral surface 113 of the inner conducting core 11. The conductive layer 15 is configured to cover the outer peripheral surface of the insulation layer 13, and the outer sheath 17 is configured to cove the outer peripheral surface of the conductive layer 15.

In one embodiment of this disclosure, the inner conducting core 11 may be a conducting wire, such as a copper wire, and includes two end points 111 and an outer peripheral surface 113, wherein the outer peripheral surface 113 is located between the two end points 111. The insulation layer 13 covers the outer peripheral surface 113 of the inner conducting core 11, wherein the insulation layer 13 may be an inner dielectric insulator, such as Expanded Polyethylene (EPE) or polytetrafluoroethylene tape (PTFE tape).

The conductive layer 15 covers the outer peripheral surface of the insulation layer 13, wherein the conductive layer 15 can be a single-layer or multi-layer structure. For example, the transmission line 10 may use braided metal wire, woven aluminum foil or woven aluminum foil forming the conductive layer 15, and then a metallic Mylar or a Faraday cage is provided on the outer peripheral surface 113 of the inner conducting core 11 to prevent the inner conducting core 11 from the energy loss and being interfered by external electromagnetic.

In another embodiment of this disclosure, the conductive layer 15 may be two-layers or multi-layers structure, and may include a mesh conductor and an A1 Mylar, wherein the A1 Mylar covers the insulation layer 13, and the mesh conductor covers the A1 Mylar. Specifically, the insulation layer 13 is located between the inner conducting core 11 and the conductive layer 15, which is configured to isolate the inner conducting core 11 and the conductive layer 15, and maintain the distance between the outer peripheral surface 113 of the inner conductor core wire 11 and the conductive layer 15.

An outer sheath 17, such as jacket, covers the outer peripheral surface of the conductive layer 15, wherein the outer sheath 17 is made of insulating material. The outer sheath 17 has functions, such as insulation and waterproofing, and is used to protect and fix the conductive layer 15 to improve the structural strength of the transmission line 10. For example, the outer cover layer 17 includes polyvinyl chloride (PVC), low density polyethylene (LDPE), fluorinated ethylene propylene copolymer (FEP), or thermoplastic elastomer (TPE). Specifically, the transmission line 10 of the embodiment may be a coaxial cable.

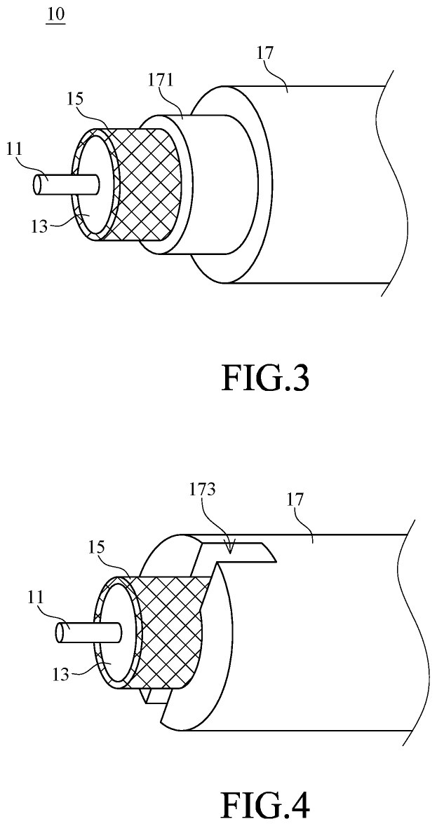

As shown in FIG. 3, when the transmission line 10 is used to be connected to other devices, such as connectors, the insulation layer 13, the conductive layer 15 and the outer sheath 17 at one or both ends of the transmission line 10 will be removed. Thus, the inner conducting core 11, the insulation layer 13 and/or the conductive layer 15 at one or both ends of the transmission line 10 will be exposed.

A thinned part 171 is provided on the outer sheath 17 at one or both ends of the transmission line 10, wherein the cross-sectional area of the thinned part 171 is smaller than that of the outer sheath 17. In one embodiments of this disclosure, the transmission line 10 may be similar to a columnar body, and the thickness of the outer sheath 17 may be uniformly thinned along the radial direction of the columnar body by grinding or cutting. Thus, the outer diameter of the thinned part 171 is smaller than that of the outer sheath 17. For example, the cross-sections of the outer sheath 17 and the thinned part 171 are both annular.

In one embodiment of this disclosure, as shown in FIG. 4, the thinned part 171 of the outer sheath 17 may be a groove 173. For example, the groove 173 may concave along the radial direction of the outer sheath 17. In addition, the groove 173 may pass through the outer sheath 17 and communicate with the conductive layer 15, and the conductive layer 15 in the groove 173 is exposed.

In another embodiment of this disclosure, as shown in FIG. 5, the thinned part 171 of the outer sheath 17 may be a cutting part 175. For example, two symmetrical cutting parts 171 are formed on the outer sheath 17. The cutting part 175 may include a cutting surface 1751, wherein the cutting surface 1751 may be a secant of the circular cross-section of the outer sheath 17.

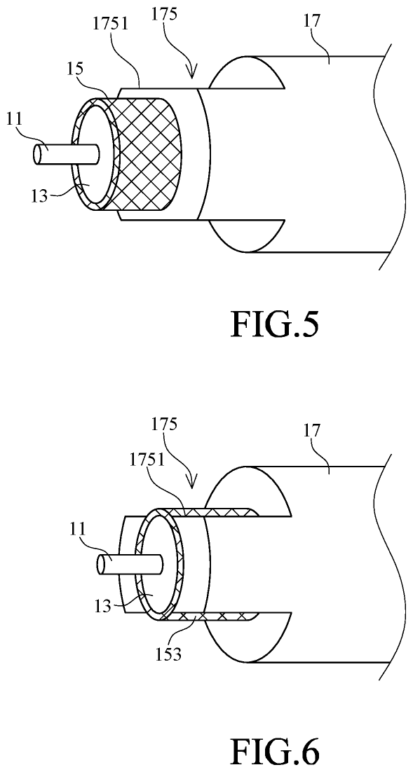

In another embodiment of this disclosure, as shown in FIG. 6, the cutting surface 175 of the cutting part 175 may connect to the conductive layer 15, and the conductive layer 15 located in the cutting part 175 is exposed to form an exposed conductive layer 153.

As shown in FIG. 1 and FIG. 2, the conductive layer 15 covering the outer peripheral surface of the insulation layer 13 can be folded to the thinned part 171 to form a folded part 151 on the thinned part 171, wherein the folded part 151 and the conductive layer 15 are kept connected. In other embodiments, the folded part 151 of the conductive layer 15 may be located in the groove 173 or the cutting part 175 of the thinned part 171.

In practical application, as shown in FIG. 2, the conductive layer 15 that is not covered by the outer sheath 17 may be disassembled and folded to the thinned part 171 to cover the end face 1711 and the outer peripheral surface 1713 of the thinned part 171. Thereafter, the insulation layer 13 originally covered by the conductive layer 15 will be exposed.

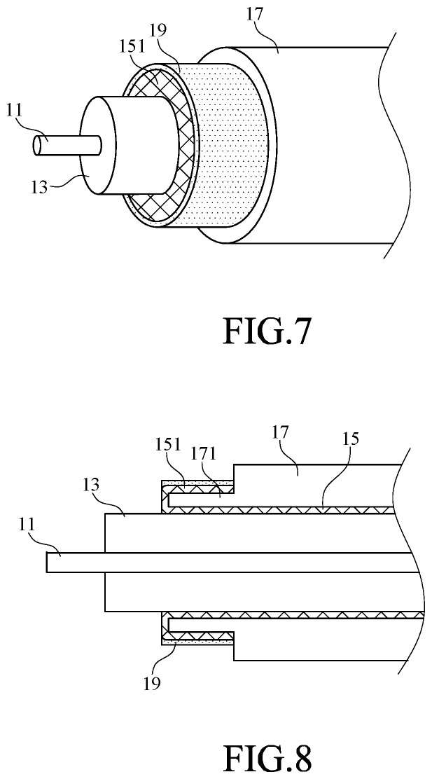

As shown in FIG. 7 and FIG. 8, a metal conductive layer 19 may be further provided on the folded part 151. For example, the metal conductive layer 19 may be copper foil, and is configured to cover the folded part 151 of the conductive layer 15. In another embodiment of this disclosure, it is not necessary to provide the metal conductive layer 19 on the surface of the folded part 151, and the metal conductive layer 19 is not a limitation of the scope of this disclosure.

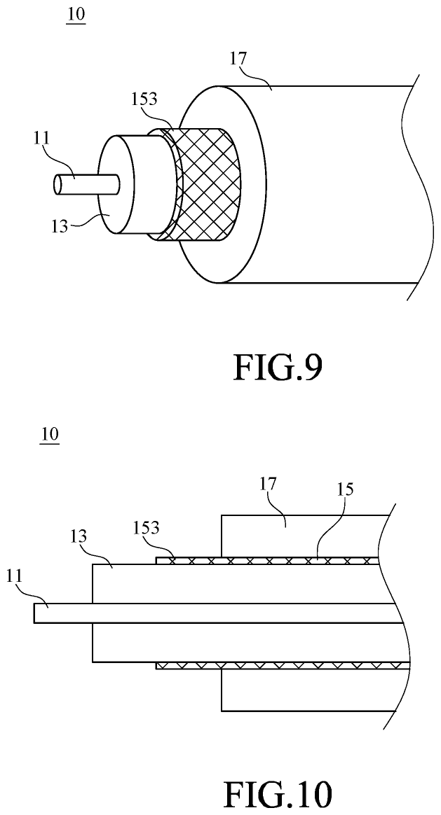

In another embodiment of this disclosure, as shown in FIG. 9 and FIG. 10, the outer sheath 17 and/or the conductive layer 15 at one or both ends of the transmission line 10 may be removed, and part of the insulation layer 13 and part of the conductive layer 15 are exposed to form the exposed conductive layer 153 at one or both ends of the transmission line 10, wherein the diameter of the exposed conductive layer 153 is smaller than that of the outer sheath 17. In this embodiment, it is not necessary to provide the folded part 151 and the thinned part 171 on the outer sheath 17 at one end or both ends of the transmission line 10.

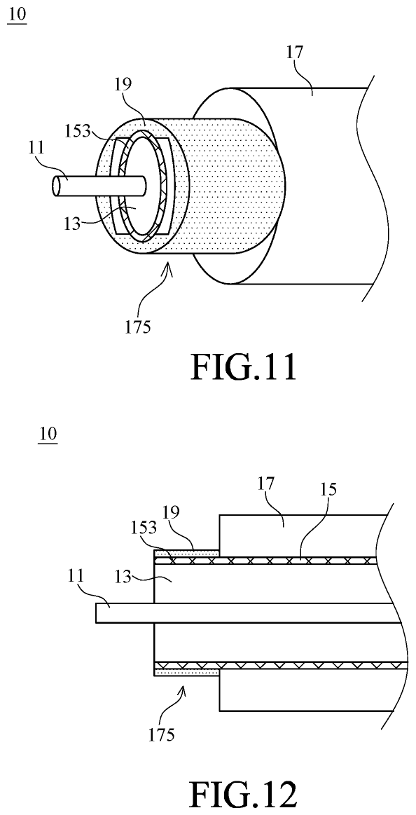

As shown in FIG. 11 and FIG. 12, the metal conductive layer 19 may be formed on the surface of the exposed conductive layer 153 exposed on the thinned part 171, the groove 173 or the cutting part 175 of FIG. 6. It is not necessary to fold the conductive layer 15 to the groove 173 or the cutting part 175. The metal conductive layer 19 is configured to cover the exposed conductive layer 153, the thinned part 171, the groove 173 and/or the cutting part 175, and the cross-section of the metal conductive layer 19, the cutting part 175 and the exposed conductive layer 153 may be approximately elliptical, oval or rectangular.

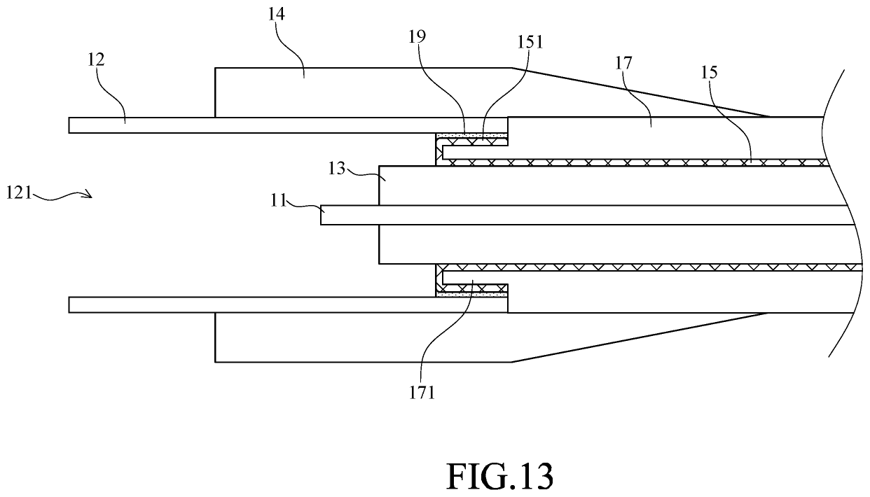

As shown in FIG. 13, one end of the transmission line 10 of FIG. 1, FIG. 2, FIG. 7 and FIG. 8 may be provided with a metal shell 12, wherein the metal shell 12 is configured to cover and contact the metal conductive layer 19 and/or the folded part 151 of the conductive layer 15. In one embodiment of this disclosure, the metal shell 12 may be a hollow sleeve and have an accommodation space 121. The metal shell 12 is configured to cover one end of the transmission line 10, and the metal conductive layer 19, the folded part 151, the thinned part 171, the insulation layer 13 and/or the inner conducting core 11 are located in the accommodation space 121 of the metal shell 12. For example, the metal shell 12 may be disposed on the radially outer side of the thinned part 171 of the outer sheath 17, and the folded part 151 disposed on the thinned part 171 will contact inner surface of the metal shell 12.

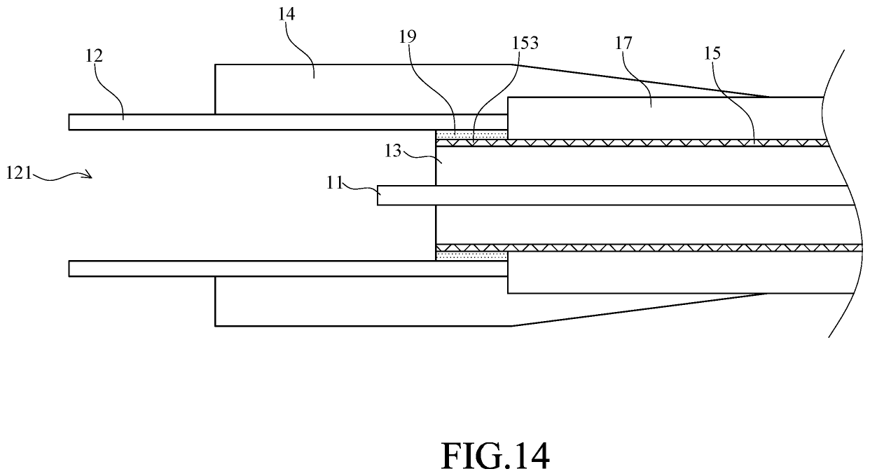

As shown in FIG. 14, one end of the transmission line 10 of FIG. 9, FIG. 10, FIG. 11 and FIG. 12 may be provided with the metal shell 12, wherein the metal conductive layer 19 covers the exposed conductive layer 153, and the metal shell 12 is configured to cover the metal conductive layer 19, so that the metal conductive layer 19, the exposed conductive layer 153, the insulation layer 13 and/or the inner conducting core 11 are located in the accommodation space 121 of the metal shell 12.

In another embodiment of this disclosure, the metal shell 12 may have two independent elements for sandwiching the metal conductive layer 19 and/or folded part 151. The two independent elements of the metal shell 12 are fixed by rivets or screws to clamp the metal conductive layer 19 and/or the folded part 151 of the transmission line 10. Thereafter, part of the metal shell 12 and part of the outer sheath 17 of the transmission line 10 are covered by the insulation shell 14 to further stabilize the connection between the metal shell 12 and the transmission line 10.

In practical application, a circuit board, a connection interface or a control unit may be disposed in the accommodation space 121 of the metal shell 12 to form a connector, such as a USB connector, a Type-C USB connector or an HDMI connector, etc. Thus, the height or width of the metal shell 12 must comply with the relevant specifications of the connector, and the sizes of the metal shell 12 and the accommodation space 121 are limited.

The height and width of the accommodation space 121 must be larger than the outer diameter of the transmission line 10, so that the transmission line 10 can be arranged in the accommodation space 121 of the metal shell 12. Therefore, the size of the metal shell 12 and the accommodation space 121 will inevitably limit the wire diameters of the transmission line 10 and the inner conducting core 11.

The size of the wire diameter of the inner conducting core 11 will affect the signal transmission distance of the transmission line 10. Specifically, if the wire diameter of the inner conducting core 11 is larger, the signal transmission distance of the transmission line 10 will increase accordingly. On the contrary, if the wire diameter of the inner conducting core 11 is smaller, the signal transmission distance of the transmission line 10 will be reduced. Therefore, for the conventional transmission line, when the height or width of the metal shell 12 and the accommodation space 121 are small, the wire diameter and signal transmission distance of the transmission line will be reduced.

Thus, this disclosure proposes to provide a thinned part 171 on the outer sheath 17 at one or both ends of the transmission line 10, as shown in FIG. 1 and FIG. 2, and then the folded part 151 and/or the metal conductive layer 19 are formed on the thinned part 171 of the outer sheath 17, as shown in FIG. 7 and FIG. 8.

Specifically, through the design of the transmission line 10 according to this disclosure, the cross-sectional area, outer diameter, height and/or width of the thinned part 171 are smaller than the outer sheath 17. When the transmission line 10 connects to the metal shell 12 and the accommodation space 121 with the same size and/or shape, the wire diameter and cross-sectional area of the transmission line 10 and the inner conducting core 11 can be increased, and the signal transmission distance can be increased.

In addition, this disclosure further proposes to remove the outer sheath 17 and/or the conductive layer 15 at one or both ends of the transmission line 10, as shown in FIG. 9 and FIG. 10, or form the thinned part 171, the grooves 173 or the cutting parts 175 at one end or both ends of the transmission line 10, wherein the conductive layer 15 is exposed on the thinned part 171, the grooves 173 or the cutting parts 175 to form the exposed conductive layer 153, as shown in FIG. 6. Then, the metal conductive layer 19 is disposed on the exposed conductive layer 153, as shown in FIG. 11 and FIG. 12. Similarly, under the condition that the size and/or shape of the metal shell 12 and the accommodation space 121 are the same, the wire diameter and cross-sectional area of the transmission line 10 and the inner conducting core 11 connected to the metal shell 12 can be increased, and the signal transmission distance of the transmission line 10 can be increased.

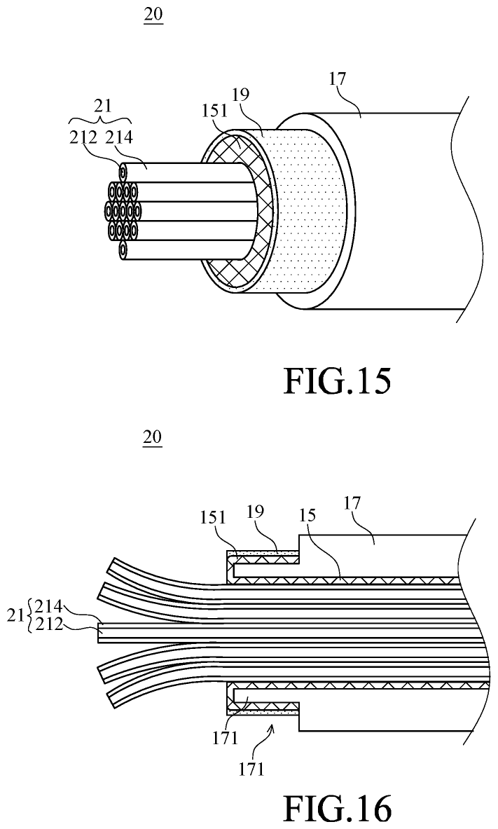

FIG. 15 is a schematic three-dimensional of a transmission line according to another embodiment of this disclosure. FIG. 16 is an axial cross view of the transmission lien according to another embodiment of this disclosure. The transmission line 20 includes a plurality of conducting wires 21, a conductive layer 15 and an outer sheath 17, wherein the conductive layer 15 covers the conducting wires 21, and the outer sheath 17 covers the outer periphery of the conductive layer 15.

The conducting wire 21 includes an inner conducting core 212 and an insulation layer 214, wherein the insulation layer 214 covers the outer peripheral surface of the inner conducting core 212. In other embodiments, the conducting wires 21 may include a conductive layer and/or a covering sheath, wherein the conductive layer covers the insulation layer 214, and the covering sheath covers the conductive layer to form a structure similar to the transmission line 10.

The conductive layer 15 of the transmission line 20 may be a single-layer or multi-layer structure. For example, the transmission line 10 may use braided metal wire, woven aluminum foil or woven aluminum foil forming the mesh conductive layer 15.

The outer sheath 17 is made of the insulating material, such as polyvinyl chloride (PVC), low density polyethylene (LDPE), fluorinated ethylene propylene copolymer (FEP) or thermoplastic elastomer (TPE).

The conductors 21 at one or both ends of the transmission line 20 of this disclosure are not covered by the conductive layer 15 and the outer sheath 17, and part of the conductive layer 15 is not covered by the outer sheath 17.

In addition, a thinned part 171 is formed on the outer sheath 17 at one or both ends of the transmission line 20, wherein the cross-sectional area and/or the outer diameter of the thinned part 171 is smaller than that of the outer sheath 17. For example, the outer sheath 17 may be uniformly thinned in the radial direction to form the thinned part 171 on the outer sheath 17. In other embodiments, the grooves 173 or the cutting parts 175 may be provided on the outer sheath 17 to form the structure similar to FIG. 4 to FIG. 5.

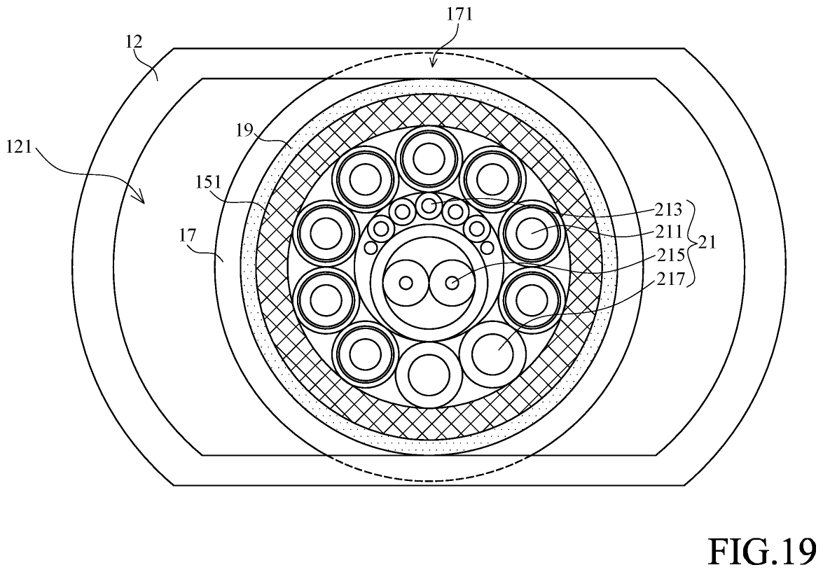

As shown in FIG. 15, FIG. 16 and FIG. 19, the conductive layer 15 without covering by the outer sheath 17 can be folded to the thinned part 171 to form a folded part 151 on the thinned part 171. For example, the folded part 151 may be located in the grooves or the cutting parts. Afterwards, a metal conductive layer 19 may be disposed on the folded part 151. For example, the metal conductive layer 19 may be copper foil, and is wound on the folded part 151. The metal shell 12 is used to cover the metal conductive layer 19 and/or the folded part 151, and the insulation shell 14 can be provided on part of the metal shell 12 and part of the outer sheath 17 of the transmission line 20 to form the structure similar to that shown in FIG. 13.

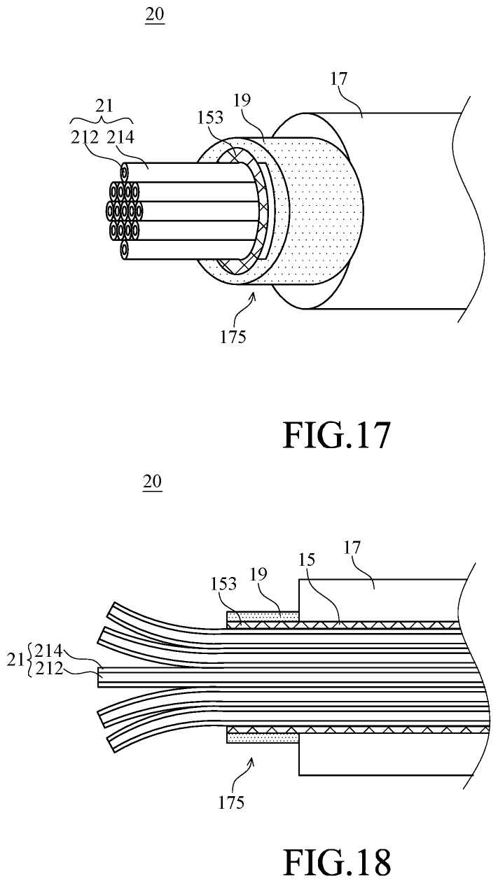

In another embodiment of this disclosure, as shown in FIG. 17 and FIG. 18, the cutting part 175 may connect to the conductive layer 15, and the conductive layer 15 on the cutting part 175 is exposed. Then, the metal conductive layer 19 may be directly disposed on the exposed conductive layer 153 exposed on the groove 173 or the cutting part 175 without folding the conductive layer 15 to the groove 173 or the cutting part 175.

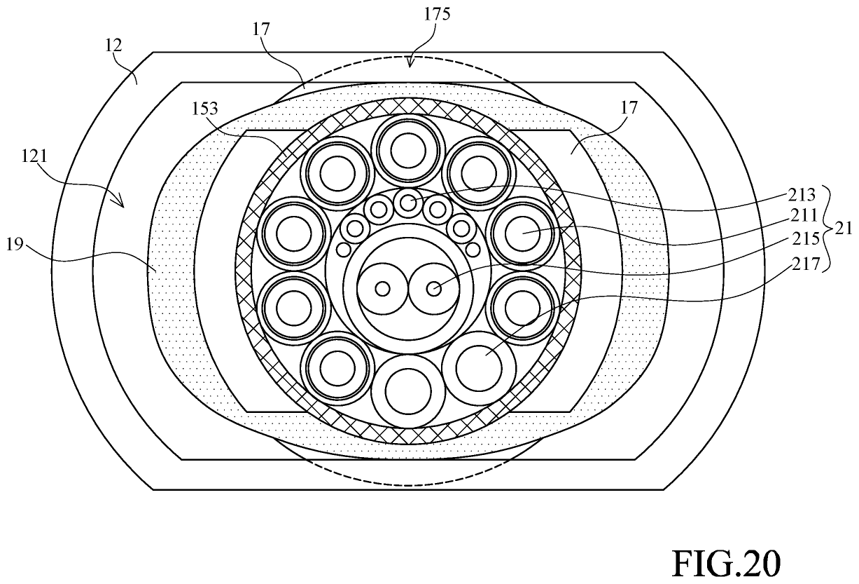

As shown in FIG. 20, the metal conductive layer 19 may be disposed on the exposed conductive layer 153 of the transmission line 20 described in FIGS. 17 and 18, wherein the exposed conductive layer 153 is located in the thinned part 171, the grooves 173 or the cutting parts 175. Taking the exposed conductive layer 153 on the cutting parts 175 as an example, the metal conductive layer 19 may be directly wound on the cutting part 175 and the exposed conductive layer 153, and the section of the metal conductive layer 19, the cutting part 175 and the exposed conductive layer 153 is approximately elliptical. Then, the metal conductive layer 19 can be covered through the metal shell 12, and a part of the metal conductive layer 19 and a part of the outer sheath 17 can be covered by the insulation shell 14 to form the structure similar to that described in FIG. 14. In this embodiment, it is not necessary to fold the conductive layer 15 to the thinned part 171, the groove 173 or the cutting part 175, which can improve the convenience of installation.

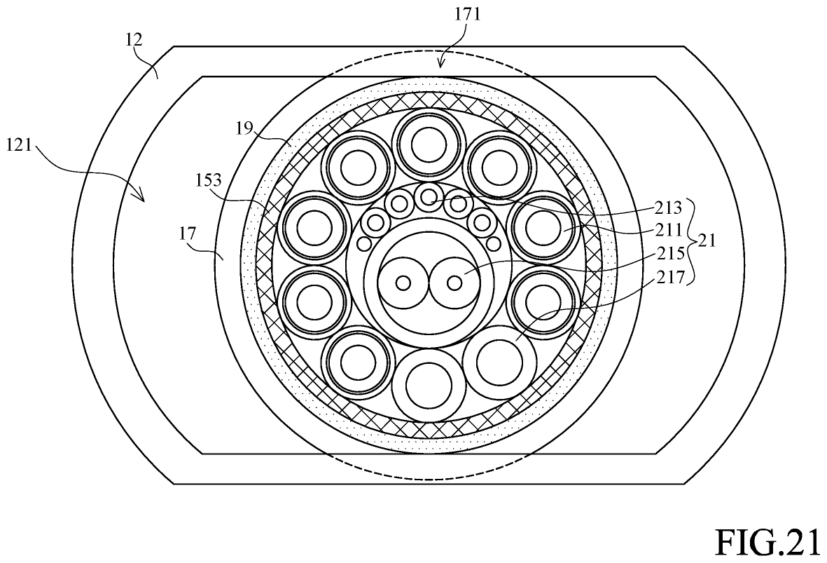

As shown in FIG. 21, the outer sheath 17 at one end or both ends of the transmission line 20 can be removed, so that part of the conductive layer 15 is exposed to form the exposed conductive layer 153 at one end or both ends of the transmission line 20, wherein the wire diameter of the exposed conductive layer 153 is smaller than the wire diameter of the outer sheath 17. Then, the metal conductive layer 19 and the metal shell 12 are sequentially disposed outside the exposed conductive layer 153. In this embodiment, it is not necessary to provide the thinned part 171 on the outer sheath 17 at one end or both ends of the transmission line 20, and fold the exposed conductive layer 15.

As shown in FIG. 19, FIG. 20 and FIG. 21, a plurality of conducting wires 21 is disposed in the conductive layer 15 of the transmission line 20, and the conducting wires 21 may include at least one first conducting wire 211, at least one second conducting wire 213, at least one third conducting wire 215 and/or at least one fourth conducting wire 217. For example, the first conducting wire 211 may be a signal wire, a metal wire or a coaxial cable, the second conducting wire 213 may be a CC wire, an SBU1 wire, an SBU2 wire and/or a Vconn wire, etc., the third conducting wire 215 may be a drain wire, and the fourth conducting wire 217 may be a power wire. Thus, the transmission line 20 will have the functions of signal transmission, energy transmission or grounding

Specifically, the transmission line 20 of this disclosure may be a high frequency transmission line, such as a USB transmission line or an HDMI connector, and the metal shell 12 forms a USB connector, a Type-C USB connector or an HDMI connector.

The above description is only a preferred embodiment of this disclosure, and is not intended to limit the scope of this disclosure. Modifications should be included within the scope of the patent application of this disclosure.

What is claimed is:

1. A transmission line, comprising:
an inner conducting core;
an insulation layer covering an outer peripheral surface of the inner conducting core;
a conductive layer covering an outer peripheral surface of the insulation layer;
an outer sheath covering an outer peripheral surface of the conductive layer, wherein the outer sheath at one or both ends of the transmission line includes a thinned part, and part of the conductive layer is located on the thinned part;
a metal shell covering the conductive layer on the thinned part; and
an insulation shell deposed on part of the metal shell and part of the outer sheath.

2. The transmission line according to claim 1, wherein the thinned part of the outer sheath comprises at least one groove or at least one cutting part, the conductive layer on the groove or the cutting part is exposed to form an exposed conductive layer, and the metal shell covers the exposed conductive layer.

3. The transmission line according to claim 2, further comprising a metal conductive layer covering the exposed conductive layer.

4. The transmission line according to claim 1, wherein the conductive layer is folded to the thinned part to form a folded part on the thinned part, and a cross sectional area of the folded part is smaller than that of the outer sheath.

5. The transmission line according to claim 4, wherein the thinned part of the outer sheath comprises at least one groove and at least one cutting part, and the folded part of the conductive layer is located in the groove or the cutting part.

6. A transmission line, comprising:
a plurality of conducting wires, including:
an inner conducting core;
an insulation layer covering an outer peripheral surface of the inner conductor core wire;
a conductive layer covering the plurality of conducting wires;
an outer sheath covering an outer peripheral surface of the conductive layer, wherein the outer sheath at one or both ends of the transmission line includes a thinned part, and part of the conductive layer is located on the thinned part;
a metal shell covering the conductive layer on the thinned part; and
an insulation shell covers part of the metal shell and part of the outer sheath.

7. The transmission line according to claim 6, wherein the thinned part of the outer sheath comprises at least one groove or at least one cutting part, the conductive layer on the groove or the cutting part is exposed to form an exposed conductive layer, and the metal shell covers the exposed conductive layer.

8. The transmission line according to claim 7, further comprising a metal conductive layer covering the exposed conductive layer.

9. The transmission line according to claim 8, wherein the conductive layer is folded to the thinned part to form a folded part on the thinned part, and a cross sectional area of the folded part is smaller than that of the outer sheath.

10. The transmission line according to claim 6, wherein the conducting wires comprise a signal wire, a drain wire or a power wire.
